(19) United States
(12) Patent Application Publication
(10) Pub. No.: US 2026/0145037 A1
(43) Pub. Date: May 28, 2026

(54) GOLF CLUB HEAD WITH IMPROVED PERFORMANCE

(71) Applicant: Acushnet Company, Fairhaven, MA (US)

(72) Inventors: Thomas Orrin Bennett, Carlsbad, CA (US); Ryan L. Marshall, La Jolla, CA (US); Marshall E. Garcia, Encinitas, CA (US)

(73) Assignee: Acushnet Company, Fairhaven, MA (US)

(21) Appl. No.: 18/958,569

(22) Filed: Nov. 25, 2024

(51) Int. Cl. A63B 53/04; A63B 53/08

(52) U.S. Cl. CPC A63B 53/0433; A63B 53/0412; A63B 53/08; A63B 53/0466; A63B 2053/0491

(57) ABSTRACT

A compact sized golf club head such as a fairway or hybrid type golf club head with improved performance is disclosed. More specifically, the present invention relates to compact sized golf club head with disproportionally large moment of inertia for smaller sized golf club head footprint.

### FIELD OF THE INVENTION

The present invention relates generally to a compact sized golf club head such as a fairway or hybrid type golf club head with improved performance. More specifically, the present invention relates to compact sized golf club head having disproportionally large moment of inertia for a smaller size golf club head footprint.

### BACKGROUND OF THE INVENTION

It is well known in the industry that an increase in moment of inertia of a golf club head may generally improve the performance of a golf club head for amateur golfers who do not always make contact with a golf ball at the center of the face. However, the reality of golf club design is not so simple, and different moment of inertia numbers may have different adverse effects on the overall performance of a golf club head that may outweigh many of the benefits traditionally associated with increasing the moment of inertia of a golf club head.

U.S. Pat. No. 4,420,156 to Campau illustrates one of the earlier patents on the concept of rotational moment of inertia, which although serves as a good basis for the concept, fails to recognize that there are numerous axis of rotation for moment of inertia in addition to the horizontal axis.

U.S. Pat. No. 7,931,546 to Bennett et al. expands upon the basic concept of moment of inertia in a golf club by highlighting that moments of inertia could have multiple different components that rotates about the center of gravity. One of the most important moment of inertia of a golf club head is the moment of inertia measured about a vertical axis passing through the center of gravity of the club head, often quantified as I_{yy}. The MOI_{yy} is generally the most important value as it quantifies the ability of the golf club head to resist twisting when hit off center in a heel and toe direction, potentially causing the golf ball to end up to the left or the right of the intended target. To complement I_{yy}, there is another moment of inertia of a golf club head measured about a horizontal axis passing through the center of gravity of the club head in a heel to toe direction, often quantified as Iₓₓ. This Iₓₓ quantifies the ability of the golf club head to resist twisting when hit off center either too high or too low on the face, resulting in a slightly less penalizing but also undesirable effect of sending the golf ball too high or too low. Finally, the last of the threesome of moment of inertia values that pairs with I_{yy} and Iₓₓ is the moment of inertial of a golf club head measured about a horizontal axis passing the center of gravity of the golf club head in a fore and aft direction, often quantified as I_{zz}. This I_{zz} quantifies the ability of the golf club head to resist twisting when hit off center along a lie axis, creating an undesirable rotational result.

One of the ways to increase the moment of inertia of a golf club head is to simply increase its size and weight, and U.S. Pat. No. 7,488,261 to Cackett et al. expands upon this by teaching a golf club head with a large mass, relatively short club length, and a moment of inertia about the I_{zz} axis through the center of gravity of the golf club head greater than 5000 grams-centimeters squared. The golf club head preferably has a volume ranging from 400 cubic centimeters to 470 cubic centimeters.

For smaller sized golf club heads such as hybrid type golf club heads, the challenge in creating an increased moment of inertia becomes much more difficult. U.S. Pat. No. 8,246,488 to Stevens et al. illustrates this inherent limitation by indicating a hybrid type golf club head having an exterior heel weight, and exterior toe weight, and interior sole weight and a stainless steel body, preferably has a moment of inertia Iₓₓ ranging from 2100 to 2300 grams, which is significantly lower than large volume golf club head.

Moreover, even if higher moments of inertias are achieved in a smaller size golf club heads, those golf club heads are often undesirable because they have too deep of a center of gravity location, quantified by a CG-C value that measures the depth of the center of gravity location relative to the shaft axis. Too deep of a center of gravity measurement can often be undesirable because it creates undesirable launch conditions often associated with excessive spin values.

Hence, based on the above, it can be seen that there is a need in the art for compact sized golf club heads such as hybrids with smaller volumes that is capable of achieving higher moments of inertia all while without sacrificing spin performance by controlling the CG-C value.

### BRIEF SUMMARY OF THE INVENTION

In some aspects, the techniques described herein relate to a compact sized golf club head including: a body portion having a crown, a sole, and a striking face; wherein said sole further includes; a toe biased sole weight receptacle, located at a toe side of said sole, and a heel biased sole weight receptacle, located at a heel side of said sole; a plurality of two or more weights, adapted interchangeable engage said toe biased sole weight receptacle and said heel biased sole weight receptacle, wherein said compact sized golf club head has a volume of between about 100 cc to about 150 cc, wherein said compact sized golf club head has a moment of inertia about a y-axis (Iyy) of greater than about 2,750 g-cm², and wherein said compact sized golf club head has a Weight Perimeter Placement Ratio of greater than about 0.61, said Weight Perimeter Placement Ratio defined as;

$$Weight Perimeter Placement Ratio = \frac{Distnace D 2 at extreme points of weight}{Overall Width D 3} .$$

In some aspects, the techniques described herein relate to a compact sized golf club head including: a body portion having a crown, a sole, and a striking face; wherein said sole further includes; a toe biased sole weight receptacle, located at a toe side of said sole, and a heel biased sole weight receptacle, located at a heel side of said sole; a plurality of two or more weights, adapted interchangeable engage said toe biased sole weight receptacle and said heel biased sole weight receptacle, wherein said compact sized golf club head has a volume of between about 100 cc to about 150 cc, wherein said compact sized golf club head has an Overall MOI value of greater than about 5,650 g-cm², and wherein said compact sized golf club head has a CG-C distance D1 of less than about 13.0 mm.

In some aspects, the techniques described herein relate to a compact sized golf club head including: a body portion having a crown, a sole, and a striking face; wherein said sole further includes; a toe biased sole weight receptacle, located at a toe side of said sole, and a heel biased sole weight receptacle, located at a heel side of said sole; a plurality of two or more weights, adapted interchangeable engage said toe biased sole weight receptacle and said heel biased sole weight receptacle, wherein said compact sized golf club head has a volume of between about 100 cc to about 150 cc, wherein said compact sized golf club head has a CG-C distance D1 of less than about 13.0 mm, and wherein said compact sized golf club head has a Weight Perimeter Placement Ratio of greater than about 0.61, said Weight Perimeter Placement Ratio defined as;

$$Weight Perimeter Placement Ratio = \frac{Distnace D 2 at extreme points of weight}{Overall Width D 3} .$$

These and other features, aspects and advantages of the present invention will become better understood with reference to the following drawings, description and claims.

### BRIEF DESCRIPTION OF THE DRAWINGS

The foregoing and other features and advantages of the invention will be apparent from the following description of the invention as illustrated in the accompanying drawings. The accompanying drawings, which are incorporated herein and form a part of the specification, further serve to explain the principles of the invention and to enable a person skilled in the pertinent art to make and use the invention.

FIG. 1 of the accompanying drawings shows an exploded view of a compact sized golf club head in accordance with an exemplary embodiment of the present invention.

FIG. 2 of the accompanying drawings shows a sole view of a compact sized golf club head in accordance with an exemplary embodiment of the present invention, allowing the unique features of the golf club head 200 to be shown more clearly.

FIG. 3 of the accompanying drawings shows an exploded view of a compact sized golf club head in accordance with an alternative embodiment of the present invention.

FIG. 4 of the accompanying drawings shows a sole view of a compact sized golf club head in accordance with an alternative embodiment of the present invention.

### DETAILED DESCRIPTION OF THE INVENTION

The following detailed description describes the best currently contemplated modes of carrying out the invention. The description is not to be taken in a limiting sense but is made merely for the purpose of illustrating the general principles of the invention, since the scope of the invention is best defined by the appended claims.

Various inventive features are described below, and each can be used independently of one another or in combination with other features. However, any single inventive feature may not address any or all of the problems discussed above or may only address one of the problems discussed above. Further, one or more of the problems discussed above may not be fully addressed by any of the features described below.

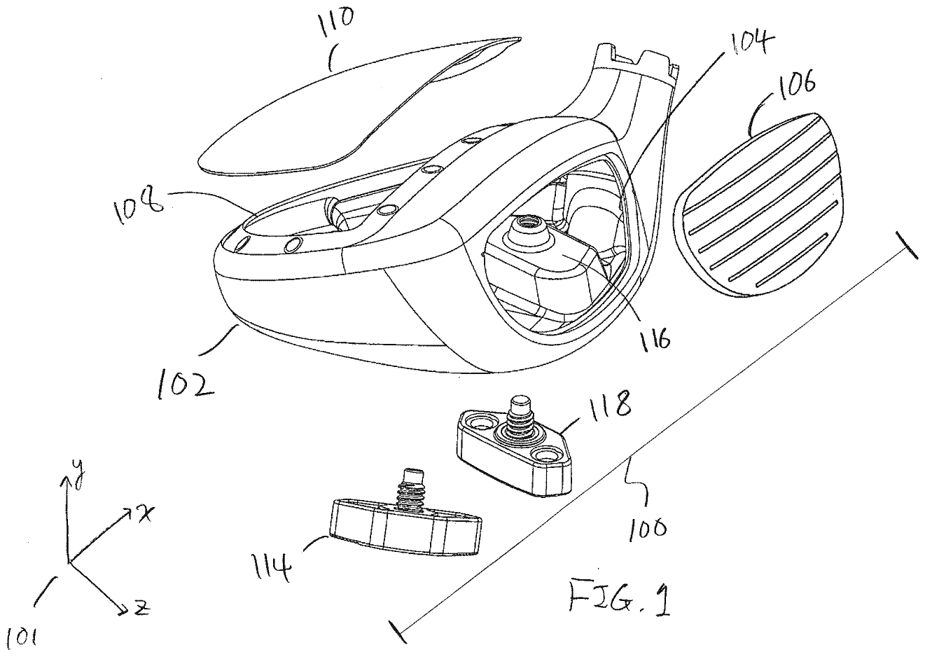

FIG. 1 of the accompanying drawings shows an exploded view of a compact sized golf club head 100 in accordance with an exemplary embodiment of the present invention. Before diving into the discussion of the compact sized golf club head 100, it is worth noting that FIG. 1 of the accompanying drawings shows a coordinate system 101 that illustrates the x-y-z axis that will be used to describe the various performance characteristics of the compact sized golf club head 100, including the moment of inertia about a specific axis. The x-axis, as defined in the present invention refers to an axis the is horizontal to the golf club head in a heel to toc direction, with the positive direction towards the heel of the compact sized golf club head 100. The y-axis, as defined in the present invention, refers to an axis that is vertically passing through the compact sized golf club head 100, with the positive direction pointed towards crown of the golf club head 100. Finally, the z-axis, as defined in the present invention, refer to an axis that is horizontal to the golf club head in a fore and aft direction, with the positive direction pointed towards the striking face of the golf club head 100.

The compact sized golf club head 100 in this embodiment may generally be a hybrid type golf club head with a volume of between about 100 cc to about 150 cc, distinguishing itself from driver type golf club heads having a volume in excess of 400 cc, and fairway wood type golf club heads having a volume of approximately 200 cc. This distinction is critical because although the ability to achieve the performance values in a larger sized golf club head may seem normal, the ability of the present invention to achieve these moment of inertia and center of gravity values in such a compact sized golf club head 100 is what sets the present invention apart. The compact sized golf club head may generally have a crown, a sole, and a striking face. The compact sized golf club head 100 may generally have a body portion 102 with a frontal opening 104 adapted to engage a striking face insert 106. The existence of a frontal opening 104 allows the a striking face insert 106 that could be of a different material to be use, allowing an improvement to the performance of the compact sized golf club head 100. In one exemplary embodiment of the present invention, the striking face insert 106 may be formed out of a high strength material that is capable of withstanding the impact forced with a golf ball, without departing from the scope and content of the present invention. In an alternative embodiment of the present invention, the striking face insert 106 could be made out of a lightweight material that increases discretionary mass, allowing more weight to be placed at alternate strategic locations of the compact sized golf club head 100 without departing from the scope and content of the present invention. In a further alternative embodiment of the present invention, the striking face insert 106 could be made out of a material that is both lightweight and high strength to achieve both of the objectives previously mentioned also without departing from the scope and content of the present invention.

In addition to having a frontal opening 104, the body portion 102 may also have a crown opening 108, adapted to engage a crown 110. The crown 110 in accordance to this embodiment of the present invention, similar to the striking face insert 106, may be made out of a different material than the body portion 102. In one embodiment, because the crown 110 portion of the compact sized golf club head 100 is not generally subjected to high stresses during impact with a golf ball, may generally be made out of a lightweight material to further create discretionary mass to be allocated to alternate more strategic locations within the compact sized golf club head 100 without departing from the scope and content of the present invention.

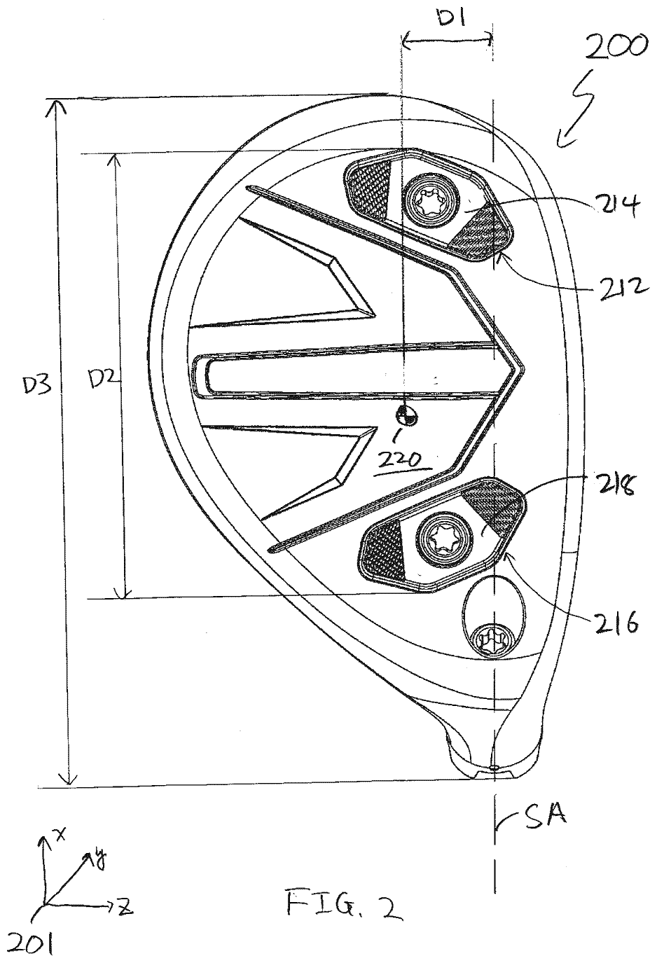

Finally, the exploded perspective view of the compact sized golf club head 100 shown in FIG. 1 shows an external toe weight 114 adapted to engage a toe biased sole weight receptacle 112 (shown in FIG. 2) located at a toc side of the sole and an external heel weight 118 located at a heel side of the sole adapted to engage a heel biased sole weight receptacle 116. In one exemplary embodiment of the present invention, the external toc weight 114 and the external heel weight 118 may be similarly sized so they can be interchangeably placed at either the to the biased sole weight receptacle 112 (shown in FIG. 2) or the heel biased sole weight receptacle 116 without departing from the scope and content of the present invention. Alternatively speaking, it can be said that the compact sized golf club head 100 may be further comprised out of a plurality of two or more weights, adapted to interchangeably engage either the toe biased sole weight receptacle 112 and the heel biased sole weight receptacle 116.

The external toc weight 114 and the external heel weight 118 in the current exemplary embodiment of the present invention may generally be made out of steel type material; however, in alternative embodiments of the present invention, both the external toe weight 114 and the external heel weight 118 maybe partially or entirely made out of a high-density material such as tungsten without departing from the scope and content of the present invention. Moreover, the external toe weight 114 and the external heel weight 118 may be of the same weight in one embodiment to create a more neutral center of gravity location, however, in an alternative embodiment of the present invention the external toc weight 114 may be heavier than the external heel weight 118 to create a more toe biased center of gravity location, or the external heel weight 118 may be heavier than the external toe weight 114 to create a more heel biased center of gravity location also without departing from the scope and content of the present invention.

FIG. 2 of the accompanying drawings shows a sole view of a compact sized golf club head 200 in accordance with an exemplary embodiment of the present invention, allowing the unique features of the golf club head 200 to be shown more clearly. More specifically, the sole view of the compact sized golf club head 200 allows the center of gravity 220 location to be shown along the x-z plane shown by the coordinate system 201. The location of the center of gravity is important, as it is one of the key variables that define the performance of the compact sized golf club head 200. The center of gravity 220, in this embodiment of the present invention, is located at a CG-C distance D1 rearward of the shaft axis SA shown in FIG. 2. The CG-C distance D1 in accordance with the current embodiment of the present invention may generally be less than about 13.0 mm, more preferably less than about 12.5 mm, and most preferably less than about 12.2 mm. This CG-C distance D1 generally relates to the amount of spin generated by the golf club head 200 when impacting a golf ball. When the CG-C distance D1 is too great, resulting in a deeper center of gravity, the compact sized golf club head 200 may generally have the undesirable result of generating too much spin.

The reduced depth of CG-C distance D1, although critical in improving the performance of the compact sized golf club head 200, does not paint the whole story regarding the overall performance of the compact sized golf club head 200. What makes the improvement of the current inventive compact sized golf club head 200 impressive is the ability to achieve the CG-C distance D1 above in combination without sacrificing the moment of inertia of the compact sized golf club head 200. The moment of inertia of a compact sized golf club head 200 cannot be quantified by one simple number, but is a collection of values, which will be discussed below.

Due to the fact that off center impact with a golf ball that are to the heel and toc produce the most detrimental results, one of the most important moment of inertia values for the compact sized golf club head 200 is the moment of inertia about the y-axis (I_{yy}), which relates to moment of inertia of the compact sized golf club head 200 measured about a vertical axis passing through the center of gravity. The current compact sized golf club head 200 in accordance with the present invention may generally have an I_{yy} of greater than about 2,750 g-cm², more preferably greater than about 2,800 g-cm², and most preferably greater than about 2,850 g-cm². In addition to the I_{yy} above, the current compact sized golf club head 200 may have a moment of inertia about the x-axis (Iₓₓ) of greater than about 900 g-cm², more preferably greater than about 950 g-cm², and most preferably greater than about 1,000 g-cm². The Iₓₓ of the golf club head relates to the moment of inertia of the compact sized golf club head 200 measured about a horizontal axis passing through the center of gravity in a heel to toe direction. The third moment of inertia value of relevance for the current compact sized golf club head 200 is the moment of inertia about the z-axis (I_{zz}), which relates to the moment of inertia of the compact sized golf club head 200 measured about a horizontal axis passing through the center of gravity in a fore and aft direction. The I_{zz} of the current compact sized golf club head 200 may generally be greater than about 2,000 g-cm², more preferably greater than about 2,100 g-cm², and most preferably greater than about 2,200 g-cm².

It is worth noting here that the moment of inertia about a shaft axis (I_{SA}) is another key performance variable in a golf club head that quantifies the ability of the compact sized golf club head 200 to resist twisting about a shaft axis SA as it impacts a golf ball. Generally speaking, this value directly relates to the distance of the center of gravity away from the shaft axis SA along a three-dimensional space, which the CG-C above forms an important part of. The current compact sized golf club head 200 may generally have a I_{SA} of greater than about 5,000 g-cm², more preferably greater than about 5,100 g-cm², and most preferably greater than about 5,200 g-cm².

In addition to the I_{SA}, another common way to quantify the overall moment of inertia performance of a golf club head is the “Overall MOI” value, which is defined as the sum of the Iₓₓ, I_{yy}, and I_{zz} values of the compact sized golf club head 200. The Overall MOI value of the compact sized golf club head 200 may generally be greater than 5,650 g-cm², more preferably greater than 5,850 g-cm², even more preferably greater than 6,050 g-cm³, and in extreme situations, even greater than about 6,300 g-cm² without departing from the scope and content of the present invention.

Returning to FIG. 2, it can be seen that the compact sized golf club head 200 may generally have two weight receptacles being located at the extreme perimeter portion of the compact sized golf club head 200 in the heel and toe locations. More specifically, the toe biased sole weight receptacle 212 is filled with an external toe weight 214 while the heel biased sole weight receptacle 216 is filled with an external heel weight 218. Although weights may have been previously used in golf club heads to adjust the center of gravity and moment of inertia, the present invention is unique in its placement of the weights at the extreme perimeter portion of the compact sized golf club head 200.

The extreme perimeter placement of the external toe weight 214 and the external heel weight 318 is quantified here by a Weight Perimeter Placement Ratio, which is defined as the distance D2 between the toe most portion of the external toe weight 214 and the heel most portion of the external heel weight 218 along the x-axis, divided by the overall width D3 of the compact sized golf club head 200 along the same x-axis. Equation 1 below provides the definition for Weight Perimeter Placement Ratio above:

$$Weight Perimeter Placement Ratio = \frac{Distnace D 2 at extreme points of weight}{Overall Width D 3} .$$

The distance D2 at the extreme points of the weights in accordance with the current exemplary embodiments of the present invention may generally be greater than about 67.0 mm, more preferably greater than about 67.5 mm, and most preferably greater thana bout 68.0 mm. The overall width D3 of the compact sized golf club head 200 may generally be less than about 109 mm, more preferably less than about 108 mm, and most preferably less than about 107 mm. Resultingly the Weight Perimeter Placement Ratio for the compact sized golf club head 200 in accordance with the present invention may generally be greater than bout 0.61, more preferably greater than about 0.62, and most preferably greater than about 0.63, signifying that the placement of the weights are at an extreme perimeter portion of the compact sized golf club head 200.

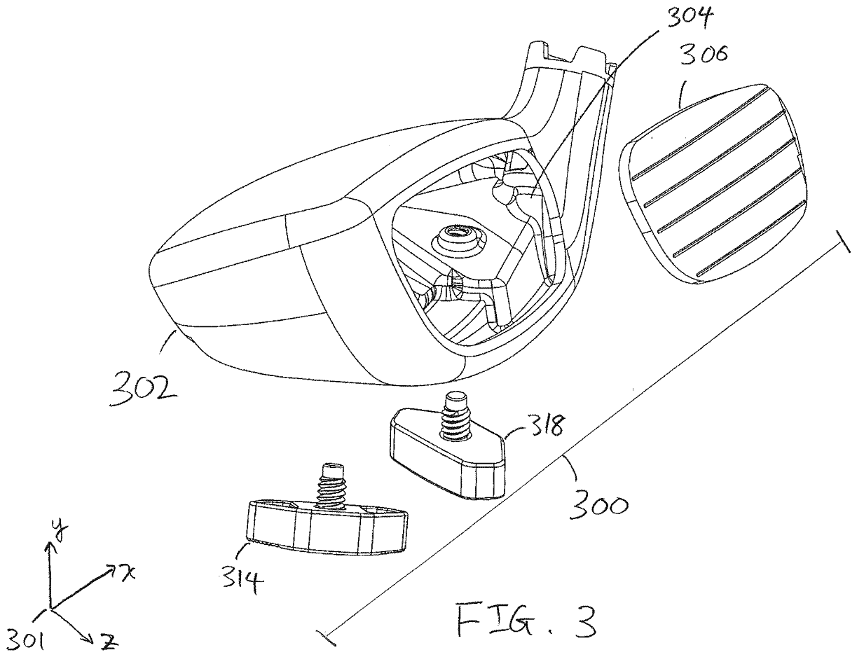

FIG. 3 of the accompanying drawings shows an exploded view of a compact sized golf club head 300 in accordance with an alternative embodiment of the present invention showing an even more compact and iron shaped profile and exhibiting similar characteristics as above. The compact sized golf club head 300 shown in FIG. 3 may generally have a body portion 302 that has a crown opening 304 adapted to engage a striking face insert 306. Similar to the previous embodiment, the compact sized golf club head 300 may have an external toe weight 314 and an external heel weight 318 placed at the extreme perimeter portions of the compact sized golf club head 300.

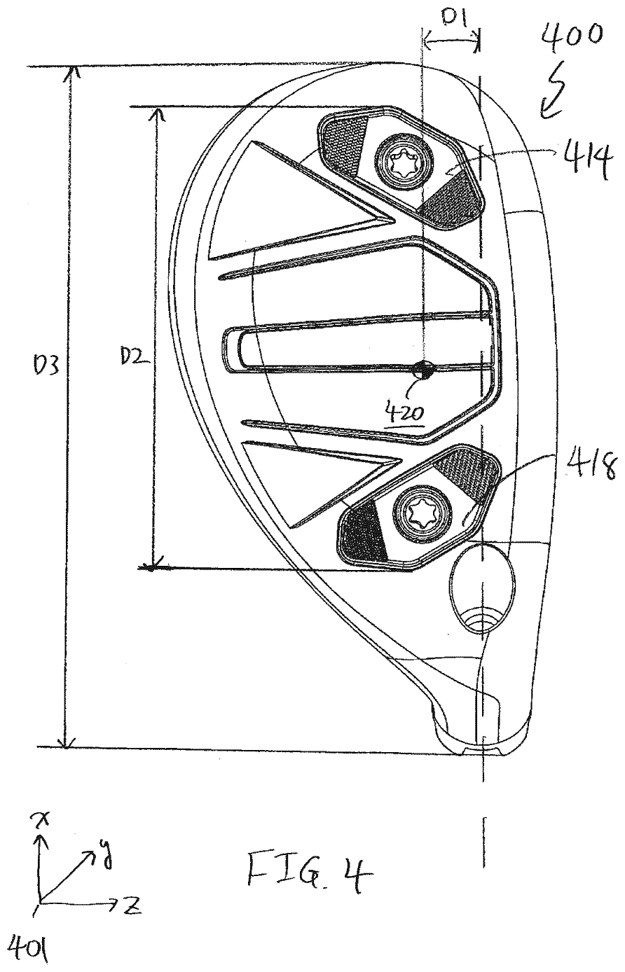

FIG. 4 of the accompanying drawings shows a sole view of a compact sized golf club head 400 in accordance with an alternative embodiment of the present invention showing an even more compact an iron shaped profile that exhibits similar characteristics. The compact sized golf club head 400 shown in FIG. 4 may have an external toe weight 414 and an external heel weight 418 that are both placed at the external perimeter of the compact sized golf club head 400 in accordance with an exemplary embodiment of the present invention. This placement of the external toe weight 414 and external heel weight 418 contribute to the center of gravity 420 location being located at a CG-C distance D1 of less than about 12.0 mm, more preferably less than about 11.0 mm, and most preferably less than about 10.5 mm without departing from the scope and content of the present invention.

Interestingly, despite the fact that the CG-C distance D1 in this even smaller compact sized golf club head 400 is slightly smaller than the previous embodiment, the Weight Perimeter Placement Ratio is similar in that it is greater than about 0.61, more preferably greater than 0.62, and most preferably greater than about 0.63, as the relative ratio of distance D2 at the extreme points of the external toe weight 414 and the external toe weight 418 to the overall width D3 of compact sized golf club head 400 remains relatively the same.

Other than in the operating example, or unless otherwise expressly specified, all of the numerical ranges, amounts, values and percentages such as those for amounts of materials, moment of inertias, center of gravity locations, loft, draft angles, various performance ratios, and others in the aforementioned portions of the specification may be read as if prefaced by the word “about” even though the term “about” may not expressly appear in the value, amount, or range. Accordingly, unless indicated to the contrary, the numerical parameters set forth in the above specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used.

It should be understood, of course, that the foregoing relates to exemplary embodiments of the present invention and that modifications may be made without departing from the spirit and scope of the invention as set forth in the following claims.

What is claimed is:

1. A compact sized golf club head comprising:
a body portion having a crown, a sole, and a striking face;
wherein said sole further comprises;
a toe biased sole weight receptacle, located at a toe side of said sole, and
a heel biased sole weight receptacle, located at a heel side of said sole;
a plurality of two or more weights, adapted interchangeable engage said toe biased sole weight receptacle and said heel biased sole weight receptacle,
wherein said compact sized golf club head has a volume of between about 100 cc to about 150 cc,
wherein said compact sized golf club head has a moment of inertia about a y-axis (I_{yy}) of greater than about 2,750 g-cm², and
wherein said compact sized golf club head has a Weight Perimeter Placement Ratio of greater than about 0.61, said Weight Perimeter Placement Ratio defined as;
$$Weight Perimeter Placement Ratio = \frac{Distnace D 2 at extreme points of weight}{Overall Width D 3} .$$

2. The compact sized golf club head of claim 1, wherein said Weight Perimeter Placement Ratio is greater than about 0.62.

3. The compact sized golf club head of claim 2, wherein said Weight Perimeter Placement Ratio is greater than about 0.63.

4. The compact sized golf club head of claim 1, wherein said moment of inertia about said y-axis (I_{yy}) is greater than about 2,800 g-cm².

5. The compact sized golf club head of claim 4, wherein said moment of inertia about said y-axis (I_{yy}) is greater than about 2,850 g-cm².

6. The compact sized golf club head of claim 1, wherein said compact sized golf club head has a moment of inertia about a shaft axis (I_{SA}) of greater than about 5,000 g-cm².

7. The compact sized golf club head of claim 6, wherein said moment of inertia about said shaft axis (I_{SA}) is greater than about 5,100 g-cm².

8. The compact sized golf club head of claim 7, wherein said moment of inertia about said shaft axis (I_{SA}) is greater than about 5,200 g-cm².

9. The compact sized golf club head of claim 1, wherein said compact sized golf club head has a CG-C distance D1 of less than about 13.0 mm.

10. The compact sized golf club head of claim 9, wherein said CG-C distance D1 is less than about 12.5 mm.

11. The compact sized golf club head of claim 10, wherein said CG-C distance D1 is less than about 12.2 mm.

12. A compact sized golf club head comprising:
a body portion having a crown, a sole, and a striking face;
wherein said sole further comprises;
a toe biased sole weight receptacle, located at a toe side of said sole, and
a heel biased sole weight receptacle, located at a heel side of said sole;
a plurality of two or more weights, adapted interchangeable engage said toe biased sole weight receptacle and said heel biased sole weight receptacle,
wherein said compact sized golf club head has a volume of between about 100 cc to about 150 cc,
wherein said compact sized golf club head has an Overall MOI value of greater than about 5,650 g-cm², and
wherein said compact sized golf club head has a CG-C distance D1 of less than about 13.0 mm.

13. The compact sized golf club head of claim 12, wherein said Overall MOI value is greater than about 5,850 g-cm², and
wherein said CG-C distance D1 is less than about 12.5 mm.

14. The compact sized golf club head of claim 13, wherein said Overall MOI value is greater than about 6,050 g-cm², and
wherein said CG-C distance D1 is less than about 12.2 mm.

15. The compact sized golf club head of claim 14, wherein said Overall MOI value is greater than about 6,300 g-cm².

16. The compact sized golf club head of claim 15, wherein said compact sized golf club head has a moment of inertia about a y-axis (I_{yy}) of greater than about 2,850 g-cm².

17. The compact sized golf club head of claim 16, wherein said compact sized golf club head has a Weight Perimeter Placement Ratio of greater than about 0.61, said Weight Perimeter Placement Ratio defined as;
$$Weight Perimeter Placement Ratio = \frac{Distnace D 2 at extreme points of weight}{Overall Width D 3} .$$

18. The compact sized golf club head of claim 17, wherein said Weight Perimeter Placement Ratio is greater than about 0.62.

19. The compact sized golf club head of claim 18, wherein said Weight Perimeter Placement Ratio is greater than about 0.63.

20. A compact sized golf club head comprising:
a body portion having a crown, a sole, and a striking face;
wherein said sole further comprises;
a toe biased sole weight receptacle, located at a toe side of said sole, and
a heel biased sole weight receptacle, located at a heel side of said sole;
a plurality of two or more weights, adapted interchangeable engage said toe biased sole weight receptacle and said heel biased sole weight receptacle,
wherein said compact sized golf club head has a volume of between about 100 cc to about 150 cc,
wherein said compact sized golf club head has a CG-C distance D1 of less than about 13.0 mm, and
wherein said compact sized golf club head has a Weight Perimeter Placement Ratio of greater than about 0.61, said Weight Perimeter Placement Ratio defined as;
$$Weight Perimeter Placement Ratio = \frac{Distnace D 2 at extreme points of weight}{Overall Width D 3} .$$
